(19) United States
(12) Patent Application Publication
(10) Pub. No.: US 2026/0341598 A1
(43) Pub. Date: Oct. 29, 2026

(54) MULTILAYER CERAMIC ELECTRONIC COMPONENT AND MANUFACTURING METHOD OF THE SAME

(71) Applicant: TAIYO YUDEN CO., LTD., Tokyo (JP)

(72) Inventor: Maiko YAMANE, Takasaki-shi (JP)

(21) Appl. No.: 19/533,713

(22) Filed: Feb. 9, 2026

(30) Foreign Application Priority Data
Mar. 27, 2025 (JP) 2025-054101

(51) Int. Cl. H01G 4/12; H01G 4/30

(52) U.S. Cl. CPC H01G 4/129; H01G 4/30

(57) ABSTRACT

A multilayer ceramic electronic component includes an element body having a multilayer body including a pair of covers that cover a capacity section formed by alternately stacking first and second internal electrode layers along a first direction, and a side margin that covers the multilayer body from a second direction. In a cross section of the element body, the cover and the side margin each include a glass grain and crystal grains of same composition surrounding the glass grain, a number of the crystal grains of the same composition surrounding the glass grain being five or more on average, and an average number of the crystal grains of the same composition surrounding the glass grain in the cover is equal to or within ±20% of the average number of the crystal grains of the same composition surrounding the glass grain in the side margin.

### CROSS-REFERENCE TO RELATED APPLICATION

This application is based upon and claims the benefit of priority of the prior Japanese Patent Application No. 2025-054101, filed on Mar. 27, 2025, the entire contents of which are incorporated herein by reference.

### FIELD

A certain aspect of the present invention relates to a multilayer ceramic electronic component and a manufacturing method of the multilayer ceramic electronic component.

### BACKGROUND

Conventionally, multilayer ceramic electronic components such as multilayer ceramic capacitors have been known, each having a capacity section in which internal electrodes and dielectric layers are alternately stacked. Recently, with the advancement of electronic devices such as smartphones, there has been a demand for higher capacitance and smaller size in multilayer ceramic capacitors. In response to these demands, proposals have been made to retrofit side margins to the sides of the multilayer body (see, for example, Japanese Patent Application Publication No. 2012-209539).

### SUMMARY OF THE INVENTION

According to an aspect of the present invention, there is provided a multilayer ceramic electronic component including: an element body having a multilayer body including a pair of covers that cover a capacity section formed by alternately stacking first internal electrode layers and second internal electrode layers along a first direction with a dielectric layer sandwiched therebetween, the dielectric layer being mainly composed of ceramic crystal grains, from both sides in the first direction, and a side margin that covers the multilayer body from a second direction orthogonal to the first direction; and a first external electrode formed on a surface of the element body and having the first internal electrode layer drawn out; and a second external electrode formed on the surface of the element body so as to be spaced apart from the first external electrode and having the second internal electrode layer drawn out, wherein in a cross section of the element body including the first direction and the second direction, the cover and the side margin each include a glass grain and crystal grains of same composition surrounding the glass grain, a number of the crystal grains of the same composition surrounding the glass grain being five or more on average, and an average number of the crystal grains of the same composition surrounding the glass grain in the cover is equal to or within ±20% of the average number of the crystal grains of the same composition surrounding the glass grain in the side margin.

According to an aspect of the present invention, there is provided a manufacturing method of a multilayer ceramic electronic component including: preparing an unfired multilayer body is produced, which includes a capacity section in which dielectric layers and internal electrode layers are alternately stacked along a first direction, the internal electrode layers being exposed from side faces facing a second direction orthogonal to the first direction, and a pair of covers formed by cover-forming sheet members that cover the capacity section from both sides in the first direction; forming an unfired element body by pressing the side faces of the unfired multilayer body against a side margin-forming sheet member, which is disposed on an elastic member, to punch out the side margin-forming sheet member, thereby forming a side margin on the side faces; firing the unfired element body; and forming an external electrode, wherein a main component of the cover-forming sheet member and the side margin-forming sheet member is ceramics and the cover-forming sheet member and the side margin-forming sheet member contain an organic silicon compound, and have a composition different from that of a dielectric layer-forming sheet member that forms the dielectric layer in the capacity section.

### BRIEF DESCRIPTION OF THE DRAWINGS

FIG. 1 is a perspective view of a multilayer ceramic capacitor according to an embodiment of present invention;

FIG. 2 is a cross-sectional view of a multilayer ceramic capacitor of FIG. 1 taken along line A-A;

FIG. 3 is a cross-sectional view of a multilayer ceramic capacitor of FIG. 1 taken along line B-B;

FIG. 4 is an enlarged cross-sectional view of portion X1 of a multilayer ceramic capacitor of FIG. 3;

FIG. 5A is a partial cross-sectional view schematically illustrating a microstructure of a first region Ar1 or a second region Ar2 of FIG. 4;

FIG. 5B is a partial cross-sectional view schematically illustrating a microstructure of a capacity section;

FIG. 6 is a graph of a Si concentration in a cover and a side margin included in a protective portion compared to a Si concentration in a capacity section;

FIG. 7 is a flowchart of an example of a method for manufacturing a multilayer ceramic capacitor according to an embodiment;

FIG. 8 is a perspective view of a manufacturing process for a multilayer ceramic capacitor according to an embodiment;

FIG. 9 is a perspective view of a ceramic multilayer body prepared in step S02 of a flowchart of FIG. 7;

FIG. 10 is a cross-sectional view schematically illustrating how side margins are formed in step S03 of a flowchart of FIG. 7; and

FIG. 11 is a perspective view of an element body on which a pair of side margins are formed in step S03 of a flowchart of FIG. 7.

### DETAILED DESCRIPTION

When adding side margins to the sides of a multilayer body, a layer with a different composition, such as an adhesive, may be interposed between the cover and side margins, which are located at both ends of the multilayer body in the stacking direction. As such, the layer forming the boundary between the cover and side margins is likely to be the starting point for peeling between the cover and side margins, or the starting point for cracks. Cracking can affect the chip firing process, making firing unstable and increasing the likelihood of abnormal grain growth near the boundary. Furthermore, the presence of a layer with a different composition between the cover and side margins can change decarburization behavior, cause differences in dimensional shrinkage in each direction of the chip, or generate shrinkage stress. Shrinkage stress generated in the chip can cause cracks under high bias.

Embodiments of the present invention will be described below with reference to the drawings. The drawings appropriately include mutually orthogonal Z, Y, and X axes. The Z, Y, and X directions are common throughout the drawings. The Z direction corresponds to the first direction, the Y direction corresponds to the second direction, and the X direction corresponds to the third direction.

[Overall Configuration of Multilayer Ceramic Capacitor 10]

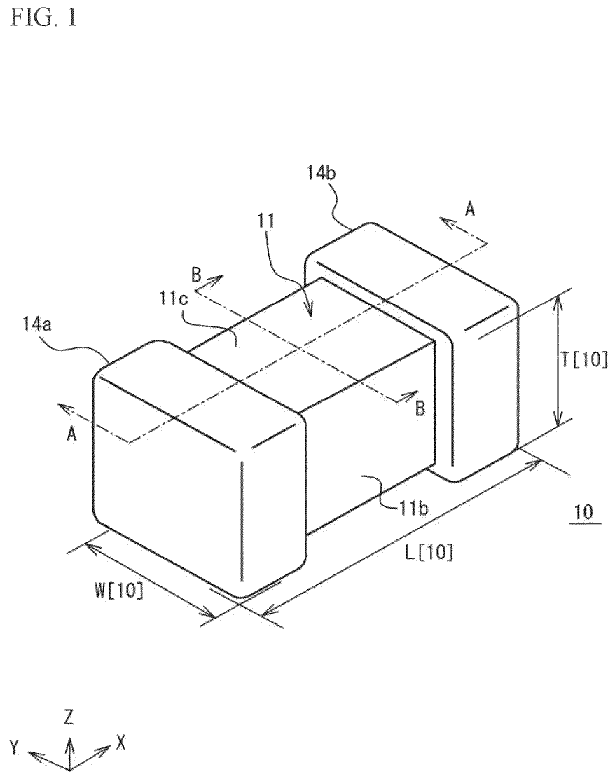

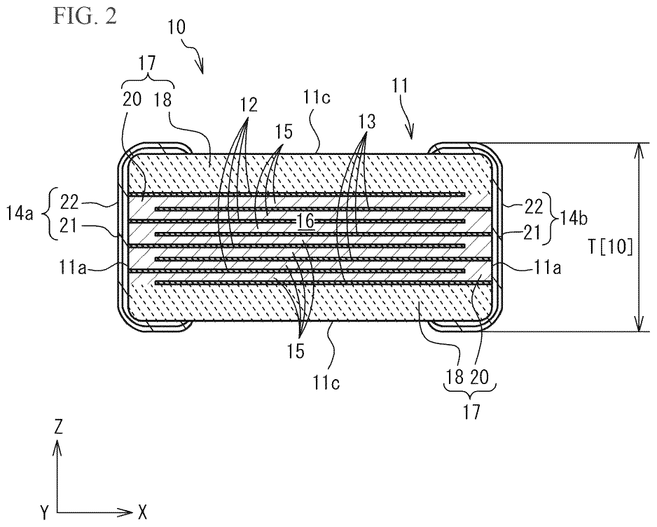

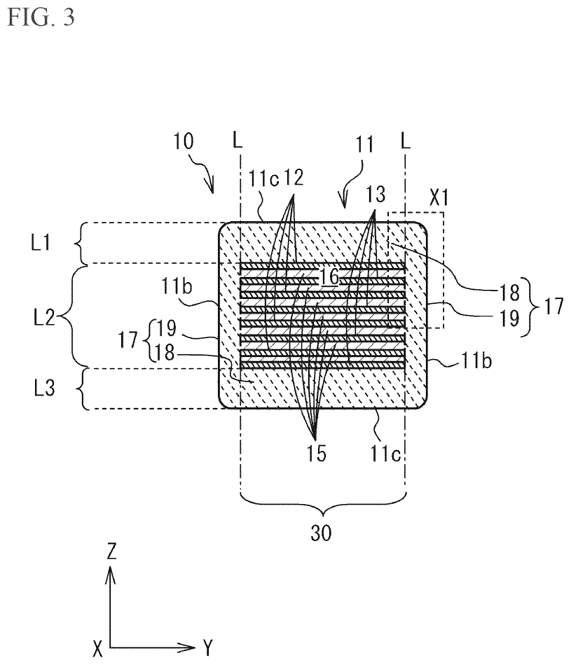

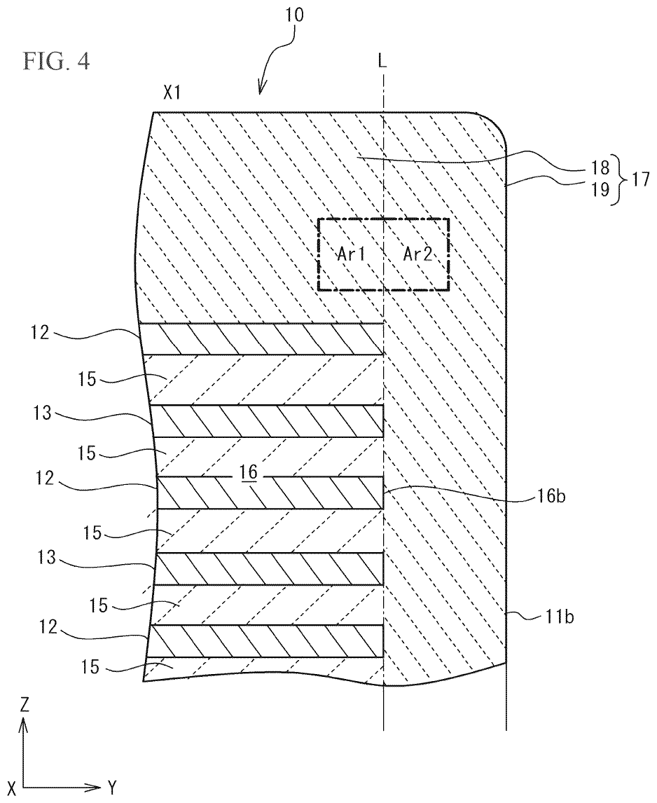

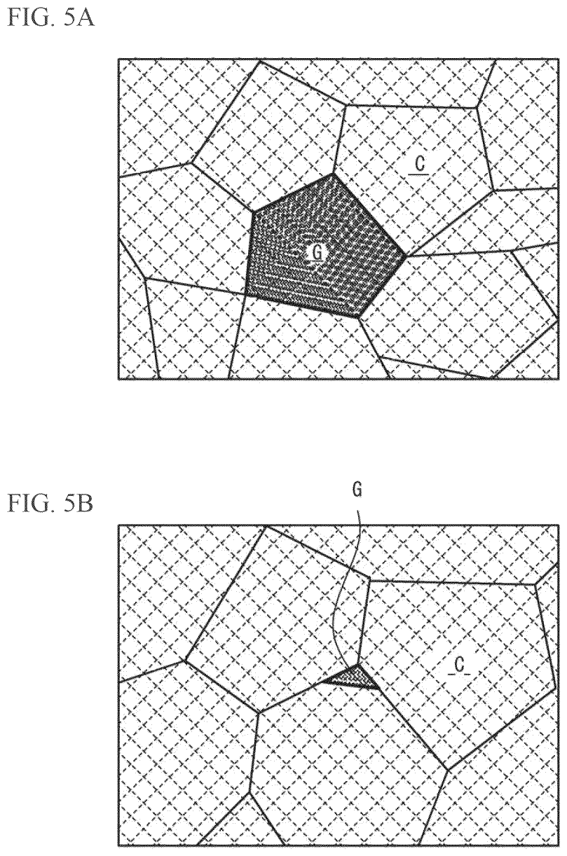

FIG. 1 to FIG. 5A are diagrams illustrating an example of a multilayer ceramic capacitor 10 according to an embodiment of the present invention. FIG. 1 is a perspective view of the multilayer ceramic capacitor 10 according to an embodiment of the present invention. FIG. 2 is a cross-sectional view of the multilayer ceramic capacitor 10 taken along line A-A in FIG. 1. FIG. 3 is a cross-sectional view of the multilayer ceramic capacitor 10 taken along line B-B in FIG. 1. FIG. 4 is an enlarged cross-sectional view of a portion X1 of the multilayer ceramic capacitor 10 in FIG. 3. FIG. 5A is a partial cross-sectional view schematically illustrating the microstructure of a first region Ar1 or a second region Ar2 in FIG. 4. FIG. 5B is a partial cross-sectional view schematically illustrating the microstructure of a capacity section 16. The cross section taken along line B-B in FIG. 3 is a cross section including the Z and Y directions, and will be referred to as the WT cross section in the following description.

The multilayer ceramic capacitor 10 includes a ceramic element body 11 having a substantially rectangular parallelepiped shape. The ceramic element body 11 includes a pair of end faces 11a facing each other in the X direction, a pair of main faces 11c facing each other in the Z direction, and a pair of side faces 11b facing each other in the Y direction. The end faces 11a, the side faces 11b, and the main faces 11c are, for example, substantially flat, but may also be rounded or may have fine irregularities on their surfaces.

A first external electrode 14a and a second external electrode 14b are provided spaced apart on the surface of the ceramic element body 11. In the example in FIG. 1 and FIG. 2, the first external electrode 14a is provided on one of the opposing end faces 11a, and the second external electrode 14b is provided on the other. The first external electrode 14a and second external electrode 14b extend to the side face 11b and main face 11c adjacent to the end face 11a, respectively. However, the first external electrode 14a and the second external electrode 14b are spaced apart from each other. In this embodiment, the first external electrode 14a and the second external electrode 14b are both U-shaped in the cross section parallel to the X-Z plane and in the cross section parallel to the X-Y plane.

Note that the first external electrode 14a and the second external electrode 14b can be provided at any position on the surface of the ceramic element body 11, as long as they are spaced apart from each other. For example, the first external electrode 14a and the second external electrode 14b may be provided spaced apart from each other on the same surface of the ceramic element body 11, or the first external electrode 14a and the second external electrode 14b may be provided spaced apart from each other on two adjacent surfaces or two opposing surfaces of the ceramic element body 11.

As long as the first external electrode 14a and the second external electrode 14b are spaced apart from each other, they may extend from the surface of the ceramic element body 11 on which they are provided to any other surface. For example, they may extend to adjacent surfaces, or may extend further from the surface to which they are attached. Furthermore, the first external electrode 14a and the second external electrode 14b do not have to extend to either of the main faces 11c or the side faces 11b.

Note that a multilayer ceramic component has the Z direction, which is the stacking direction; the Y direction, which is perpendicular to the stacking direction and intersects with two opposing surfaces; and the X direction, which is perpendicular to the Z direction and the Y direction and intersects with two opposing surfaces. The Z direction, the Y direction, and the X direction are mutually orthogonal. The stacking direction can be set in any of the length, width, and height directions of the ceramic element body 11.

The ceramic element body 11 has a configuration in which dielectric layers 15 containing a ceramic material that functions as a dielectric and internal electrode layers are alternately stacked. The internal electrode layers include a plurality of first internal electrode layers 12 and a plurality of second internal electrode layers 13. The first internal electrode layers 12 and the second internal electrode layers 13 are alternately stacked. In the illustrated example, the edge of the first internal electrode layer 12 extends to the end face 11a of the ceramic element body 11 where the first external electrode 14a is provided. The edge of the second internal electrode layer 13 extends to the end face 11a of the ceramic element body 11 where the second external electrode 14b is provided.

As a result, the first internal electrode layer 12 is electrically connected to the first external electrode 14a, and the second internal electrode layer 13 is electrically connected to the second external electrode 14b. As a result, the ceramic element body 11 has a configuration in which capacitor units are stacked, for example, the capacity section 16.

The ceramic element body 11 includes a protective portion 17 that forms the periphery of the capacity section 16. The surfaces of the protective portion 17 form the end faces 11a, the side faces 11b, and the main faces 11c.

The protective portion 17 includes a pair of covers 18 that cover the capacity section 16 from both sides in the Z direction, side margins 19 that cover the capacity section 16 from both sides in the Y direction, and end margins 20 that are located outside the capacity section 16 in the X direction.

The covers 18 are located outside the stacking direction of the capacity section 16, that is, in the illustrated example, outside the capacity section 16 in the Z direction. The side margins 19 are provided outside the capacity section 16 in a direction perpendicular to the stacking direction. As a result, the covers 18 constitute the main faces 11c of the ceramic element body 11. The side margins 19 are provided as sections that do not include the edge portions of the first internal electrode layers 12 and the second internal electrode layers 13 that are extended to the surface of the ceramic element body 11 in a direction perpendicular to the stacking direction. In other words, in the illustrated example, the side margins 19 are located outside the capacity sections 16 in the Y direction. As a result, the side margins 19 constitute the side faces 11b of the ceramic element body 11. The end margins 20 are provided outside the capacity section 16 in a direction perpendicular to the stacking direction. The end margins 20 are provided as sections including the edge portions of the first internal electrode layers 12 and the second internal electrode layers 13 that are extended to the surface of the ceramic element body 11 in a direction perpendicular to the stacking direction. That is, in the illustrated example, the end margins 20 are located outside the capacity section 16 in the X direction. As a result, the end margins 20 form the end faces 11a of the ceramic element body 11.

Here, the capacity section 16 and the pair of covers 18 that cover the capacity section 16 form a multilayer body 30. In the multilayer body 30, the first internal electrode layers 12 and the second internal electrode layers 13 are formed across the entire width in the Y direction. The positions of both ends in the Y direction of the first internal electrode layers 12 and the second internal electrode layers 13 are aligned with each other in the Y direction on the Y-direction side face of the capacity section 16, and may be aligned with each other within a range of 0.5 μm in the Y direction.

As illustrated in FIG. 3 and FIG. 4, the cover 18 and the side margin of the multilayer body 30 are in contact with each other in the Y direction at their boundary. Conventionally, the composition of the cover 18 and the composition of the side margin of the multilayer body 30 are different, making it relatively easy to observe the boundary. However, in the present invention, the composition of the cover 18 and the composition of the dielectric material of the side margin of the multilayer body 30 are the same, making it difficult to actually observe the boundary between the cover 18 and the side margin 19 in the cross section of FIG. 3 and FIG. 4. Therefore, in this specification, an imaginary boundary line L is defined to separate the cover 18 and the side margin 19. The portion of the ceramic element body 11 located inward from the imaginary boundary line L is referred to as the cover 18, and the portion located outward from the imaginary boundary line L is referred to as the side margin 19. Here, the imaginary boundary line L is defined as the connection between the first imaginary boundary line L1, the second imaginary boundary line L2, and the third imaginary boundary line L3. First, the second imaginary boundary line L2 is a straight line connecting the ends of the first internal electrode layers 12 and the second internal electrode layers 13 along the Z direction in the cross section illustrated in FIG. 3. However, the positions of the ends of the first internal electrode layers 12 and the second internal electrode layers 13 may be slightly shifted in the Y direction. In this case, the second imaginary boundary line L2 may be a curve. For convenience, the first imaginary boundary line L1 is the portion of the imaginary boundary line on the cover 18 side that contacts either the first internal electrode layer 12 or the second internal electrode layer 13, which is located adjacent to the cover 18 at the upper end in the Z direction, among the multiple internal electrodes, when a straight line extending in the Z direction is moved from the outside to the inside of the ceramic element body 11 in the Y direction. For convenience, the third imaginary boundary line L3 is the cover-side portion of the imaginary boundary line that contacts either the first internal electrode layer 12 or the second internal electrode layer 13, which is located adjacent to the cover 18 at the lower end in the Z direction among the multiple internal electrodes, when the straight line extending in the Z direction is moved from the outside to the inside in the Y direction of the ceramic element body 11.

The capacity section 16 is located inside the protective section 17 and constitutes a functional section. The capacity section 16 is composed of the multiple first internal electrode layers 12 and the multiple second internal electrode layers 13 stacked in the Z-axis direction with the dielectric layers 15 interposed therebetween. The internal electrode layers 12, 13 are both sheet-shaped extending along the X-Y plane and arranged alternately along the Z-axis direction.

The first internal electrode layers 12 and the second internal electrode layers 13 are formed from good electrical conductors and function as internal electrodes of the multilayer ceramic capacitor 10. The good electrical conductors forming the first internal electrode layers 12 and the second internal electrode layers 13 are typically materials primarily composed of base metals such as nickel (Ni), copper (Cu), and tin (Sn), or alloys containing at least one of these metals. The first internal electrode layers 12 and the second internal electrode layers 13 may also be primarily composed of precious metals such as platinum (Pt), palladium (Pd), silver (Ag), or gold (Au), or alloys containing at least one of these metals. The primary component of the first internal electrode layer 12 and the primary component of the second internal electrode layer 13 may be the same or different.

The dielectric layers 15 are formed primarily from dielectric ceramics. In the multilayer ceramic capacitor 10, a high-dielectric-constant dielectric ceramic is used to increase the capacitance of each of the dielectric layers 15 between the first internal electrode layer 12 and the second internal electrode layer 13. An example of high-dielectric-constant dielectric ceramics is such as a perovskite-structure material containing barium (Ba) and titanium (Ti), such as barium titanate (BaTiO₃).

In addition to barium titanate, the dielectric ceramic may also be strontium titanate (SrTiO₃), calcium titanate (CaTiO₃), magnesium titanate (MgTiO₃), calcium zirconate (CaZrO₃), calcium titanate zirconate (Ca(Zr,Ti)O₃), barium zirconate (BaZrO₃), or titanium oxide (TiO₂). The dielectric ceramics listed here are the main components of dielectric layer 15.

The protective portion 17 is also formed from a dielectric ceramic. However, while the cover 18 and the side margin 19 are formed from the same dielectric ceramic material, the dielectric ceramic material forming the cover 18 and the side margin 19 is different from the dielectric ceramic material forming the end margin 20 and the dielectric layer 15, that is, the capacity section 16.

Specifically, the cover 18 and the side margin 19 contain a plurality of glass grains G. In the cover 18 and the side margin 19, the amount of Si element forming the glass grains G is 3 at % or more relative to the total material forming the cover 18 and the side margin 19. The glass grains G are primarily amorphous grains, and typically contain silicon (Si) as its main component. The total volume ratio of the glass grains G to the main component ceramic in the cover 18 and the side margin 19 can be 1% or more and 20% or less. The median diameter of the glass grains G may be 0.20 μm or more and 0.80 μm or less. The capacity section 16 may also contain glass grains, but the amount is small compared to the composition of the material forming the cover 18 and the side margin 19. For example, the content of the glass grains G in the capacity section 16 may be 5% or less by volume relative to the main ceramic component. The content of the glass grains G is more preferably 3% or less by volume relative to the main ceramic component, and more preferably 1% or less by volume. By setting the content of the glass grains G to 5% or less by volume relative to the main ceramic component, sinterability can be improved without reducing capacity.

Furthermore, the cover 18 and side margin 19 differ from the capacity section 16 in the following respects.

In other words, in the cover 18 and the side margin 19, the glass grains G may be surrounded by an average of five or more crystal grains in the WT cross section. In FIG. 5A, barium titanate (BaTiO₃) grains (hereinafter referred to as BT grains) C, which are an example of crystalline grains, are illustrated with low-density hatching. Also in FIG. 5A, the glass grains G are illustrated with high-density hatching. The cover 18 and the side margin 19 have a characteristic microstructure in which the glass grains G are roughly equivalent in size to the BT grains C, which are crystalline grains. Here, the crystalline grains surrounding the glass grains G, that is, the BT grains C, may be only the BT grains C in line contact with the glass grains G, or may include BT grains C in point contact with the glass grains G. In the example illustrated in FIG. 5A, the BT grains C surrounding the glass grains G include the five BT grains C in line contact with the glass grains G, as well as the two BT grains C in point contact with the glass grains G. Therefore, the glass grains G illustrated in FIG. 5A are surrounded by the seven BT grains C. Note that the crystal grains (BT grains) surrounding the glass grain G are defined as crystal grains when there are no other grains between the glass grain G and that crystal grain. For example, if there is a BT grain C between the glass grain G and the BT grain C, that BT particle C is not included in the crystal grains surrounding the glass grain G. In the example illustrated in FIG. 5A, if the number of BT grains C in point contact is included, the number of BT grains is seven. In other words, if there is a BT grain C in point contact, that BT grain C can also be counted.

As described above, in this embodiment, in the cover 18 and the side margin 19, the glass gain G may be surrounded by an average of five or more crystal grains in the WT cross section. Furthermore, the average number of crystal grains of the same composition surrounding the glass grain G in the cover 18 is equal to the average number of crystal grains of the same composition surrounding the glass particle G in the side margin 19. Alternatively, one average is within ±20% of the other average.

As described above, this configuration may be achieved by setting the total volume ratio of the glass grains G to the main ceramic component in the cover 18 and the side margin 19 to be 1% or more and 20% or less. The size of the glass grains G is not important, as long as the condition that the number of BT grains C surrounding each glass grain G is five or more on average is met.

In contrast, in the capacity section 16, the glass grains G are significantly smaller than the BT grains C. In FIG. 5B, the BT grains C are indicated by low-density hatching. In FIG. 5B, the glass grains G are indicated by high-density hatching. In the capacity section 16, the glass grains G are significantly smaller than the BT grains C, and the glass grains G are present at the grain boundaries or grain boundary triple junctions of the BT grains C. As a result, the glass grains G illustrated in FIG. 5B are surrounded by the three BT grains C. The average number of the glass grains G surrounded by crystal grains in the capacity section 16 may be smaller than that in the cover 18 and the side margin 19.

On the other hand, in this embodiment, the dielectric material composition of the cover 18 and the dielectric material composition of the material of the side margin 19 are generally the same, and are referred to as having the same composition. “Generally the same” means that the proportion of each element in one of the material composition of the BT grains, which is the main component, is within 10% of the proportion of each element in the other. Furthermore, if the compositions are the same, the sintered grain sizes may also be the same. For example, the average grain size of the crystal grains in the cover 18 and the average grain size of the crystal grains in the side margin 19 are generally the same. Specifically, as illustrated in FIG. 4, the standard deviation of the grain sizes measured in the first region Ar1 on the cover 18 side and the second region Ar2 on the side margin 19 side, adjacent to each other across the imaginary boundary line L, is 0.05 μm or less. In other words, there is little variation in the average grain size between the two regions.

The cover 18 and side margin 19 contain the glass grains G as described above, increasing the probability that glass grains G will be present in the crack propagation path. When energy that drives the crack propagation is applied to the glass grains G, the highly viscous glass grains G act to absorb the energy applied from the crack. Because the glass grains G are large in the cover 18 and side margin 19, the glass grains G can adequately absorb the energy applied from the crack. As a result, the driving force of the crack is weakened in the glass grains G in the cover 18 and side margin 19, and the crack propagation stops.

The median size of the glass grains G is defined as the median grain size of the grains present within a specified field of view on the cross section. For example, the median size may be determined within a rectangular field of view of 30 μm×40 μm on the cross section of the cover 18 or the side margin 19. The grain size of each grain may be obtained as the equivalent circle diameter, which is calculated as the diameter of a circle having the same area as the cross section of the grain.

By setting the total volume ratio of the glass grains G to the main ceramic component in the cover 18 and the side margin 19 to be 1% or more and 20% or less and further uniformly dispersing the glass grains G throughout the polycrystalline body, the probability of the glass grains G being present in the crack propagation path can be increased. This allows the glass grains G to more reliably block the propagation of cracks that occur in the cover 18 or the side margin 19.

In particular, the cover 18 can prevent cracks that occur on the outer surface from penetrating in the Z direction and reaching the capacity section 16. Furthermore, the side margin 19 can prevent cracks that occur on the outer surface from penetrating in the Y direction and reaching the capacity section 16. This prevents insulation failure in the multilayer ceramic capacitor 10 caused by moisture penetrating into the capacity section 16 through cracks in the cover 18 or the side margin 19.

The total volume ratio of the glass grains G to the main ceramic component in the cover 18 or the side margin 19 may be estimated from the grain size of the glass grains G present within a specified field of view in the cross section of the cover 18 or the side margin 19. For example, the total volume ratio can be determined from a photograph of the cross section of the cover 18 or the side margin 19 taken using a scanning electron microscope (SEM) to capture a rectangular field of view measuring 30 μm×40 μm. In the following description, the total volume of the glass grains G present within a specified area, for example, within a rectangular field of view, is referred to as the glass volume.

Specifically, the area of each glass grain G with a maximum size of 0.05 μm or larger is measured from the cross-sectional photograph of the cover 18 or the side margin 19, and the size of each glass grain G is calculated as a circle-equivalent diameter. The spherical volume of each glass grain G is then calculated from the resulting diameter. This results in the average volume of the glass grains G. Next, the number of glass grains G in the entire cover 18 and the side margin 19 can be roughly estimated from the number of glass grains G in a square region with an area of 1 μm². The total volume of glass can then be calculated by multiplying the average volume and the number of glass grains G. The total volume ratio of glass can then be calculated as the ratio of the total volume of glass to the volume of the main component ceramic, which is obtained by subtracting the total volume of glass from the entire volume of the cover 18 and the side margin 19.

Note that if the total volume ratio of glass relative to the main component ceramic in the cover 18 and the side margin 19 is too high, the resulting excessive flexibility may impair the flatness of the outer surface during the manufacturing process, making it difficult to maintain a normal shape. For this reason, it is preferable to keep the total volume ratio of glass relative to the main component ceramic in the cover 18 and the side margin 19 to 20% or less. In order to provide glass grains G in the cover 18 and the side margin 19, a silicon source is added during the manufacturing process of the multilayer ceramic capacitor 10. In this embodiment, to obtain the glass grains G that meet the above conditions, silicon, silicon resin, silicon oligomer, or other organic silicon compounds may be used as the silicon source. In contrast, SiO₂ may be used as the silicon source for the capacity section 16. The manufacturing methods for the cover 18 and side margin 19 will be described in detail later.

In this embodiment, the cover 18 and the side margin 19 have the same composition. That is, the cover 18 and the side margin 19 each contain the glass grains G surrounded by an average of five or more crystal grains. Furthermore, the standard deviation between the grain size measured in the first region Ar1 and the grain size measured in the second region Ar2 is 0.05 μm or less. In this way, having the same composition reduces the required pressure during molding and further reduces the incidence of delamination.

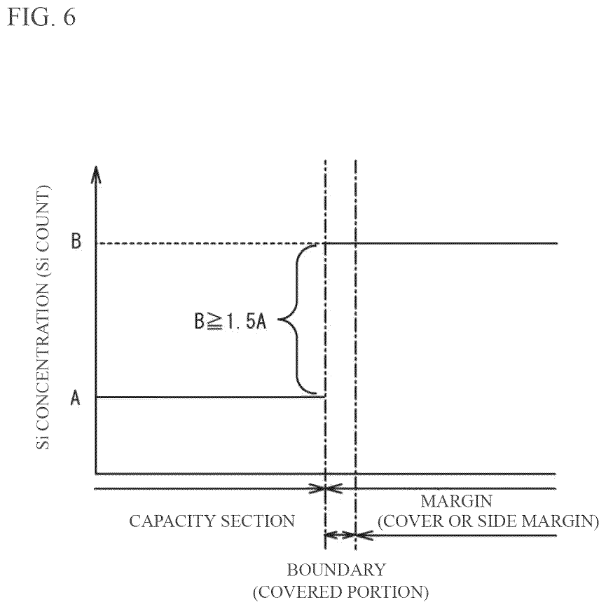

On the other hand, the Si element concentration in the cover 18 and the side margin 19 may be discontinuous with the Si element concentration in the capacity section 16. Referring to FIG. 6, the relationship between the Si element concentration in the cover 18 and the side margin 19 and the Si element concentration in the capacity section 16 will be explained. Referring to FIG. 6, the vertical axis represents the Si concentration (Si element concentration). Here, the Si element concentration is the number of Si elements detected per observation time, that is, the Si count number. The Si count number may be measured using, for example, an EPMA (electron probe microanalyzer).

In FIG. 6, the Si element concentration in the capacity section 16 is represented as A, and the Si element concentration in the cover 18 and side margin 19 is represented as B. In this embodiment, the relationship B≥1.5×A holds. In other words, the Si element concentration in the cover 18 and the side margin 19 is 1.5 times or more the Si element concentration in the capacity section 16. This difference in the Si element concentration between the capacity section 16, and the cover 18 and side margin 19, resulting in discontinuity, is thought to be due to the addition of an organosilicon compound as the Si source to the cover 18 and the side margin 19.

In this embodiment, a large amount of binder is added to the ceramic sheet forming the side margin 19 to improve adhesion of the side margin 19 to the multilayer body formed by stacking the covers 18 on the capacity section 16. Furthermore, the same ceramic sheet as the ceramic sheet forming the side margin 19 is also used to form the cover 18. Therefore, in this embodiment, the ceramic sheet forming the cover 18 has a large amount binder on its surface. The binder on the surface aids in bonding between the sheets. As a result, sufficient bonding strength can be obtained even when the pressure required to mold the multilayer body is reduced compared to conventional methods.

In addition, in this embodiment, the Si element concentrations in the cover 18 and the side margin 19 may be discontinuous with the Si element concentration in the end margin 20. This is similar to the Si element concentration in the capacity section 16 and the Si element concentrations in the cover 18 and the side margin 19 described above. In other words, the same ceramic sheet for forming the side margin 19 is also used to form the cover 18. This allows for good bonding between the cover 18 and the end margin 20.

The first external electrode 14a and the second external electrode 14b each have a base film 21 formed to cover the lead-out portions of the first internal electrode layers 12 and the second internal electrode layers 13 and part of the surface of the ceramic element body 11, and a plating film 22 formed on the base film 21. The base film 21 is composed of, for example, a baked film formed by baking a conductive paste, a sputtered film, or the like. The plating film 22 is a film formed by electrolytic plating. Each film of the external electrodes 14a, 14b is formed of a metal or alloy primarily composed of, for example, nickel (Ni), copper (Cu), tin (Sn), palladium (Pd), platinum (Pt), silver (Ag), gold (Au), or aluminum (Al). Alternatively, the external electrodes 14a, 14b can be formed by printing and drying a conductive paste containing a curable resin, such as Ag resin.

As illustrated in FIG. 1A, the dimensions of the multilayer ceramic capacitor 10 in each direction may be expressed as height T[10]×width W[10]×length L[10]. Height T[10] is the distance between the outermost positions of the multilayer ceramic capacitor 10 in the Z direction. Width W[10] is the distance between the outermost positions of the multilayer ceramic capacitor 10 in the Y direction. Length L[10] is the distance between the outermost positions of the multilayer ceramic capacitor 10 in the X direction.

The size of the multilayer ceramic capacitor 10 is, for example, Length L[10] in the X direction=0.25 mm, Width W[10] in the Y direction=0.125 mm, and Height T[10] in the Z direction=0.125 mm, or Length L[10]=0.4 mm, Width W[10]=0.2 mm, and Height T[10]=0.2 mm, or Length L[10]=0.6 mm, Width W[10]=0.3 mm, Height T[10]=0.3 mm, or Length L[10]=1.0 mm, Width W[10]=0.5 mm, Height T[10]=0.5 mm, or Length L[10]=3.2 mm, Width W[10]=1.6 mm, Height T[10]=1.6 mm, or Length L[10]=4.5 mm, Width W[10]=3.2 mm, Height T[10]=2.5 mm, but are not limited to these sizes. The size of the multilayer ceramic capacitor 10 may be, for example, Length L[10]>Width W[10]>Height T[10], Width W[10]>Length L[10]>Height T[10], Height T[10]>Length L[10]>Width W[10], or Height T[10]>Width W[10]>Length L[10].

### [Manufacturing Method of the Multilayer Ceramic Capacitor 10]

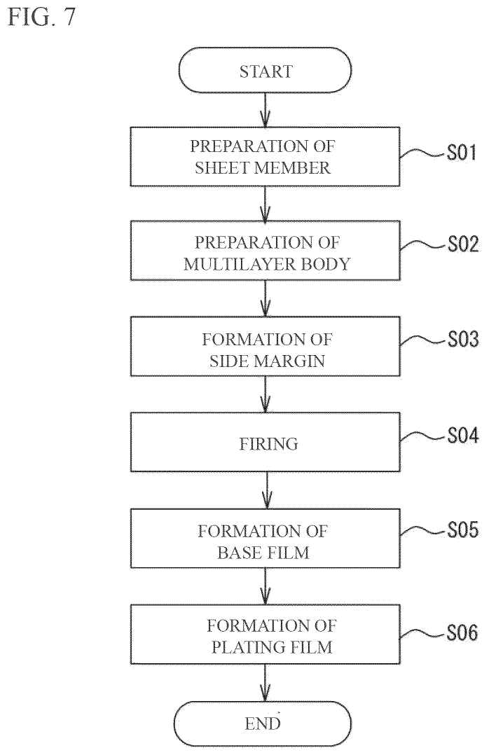

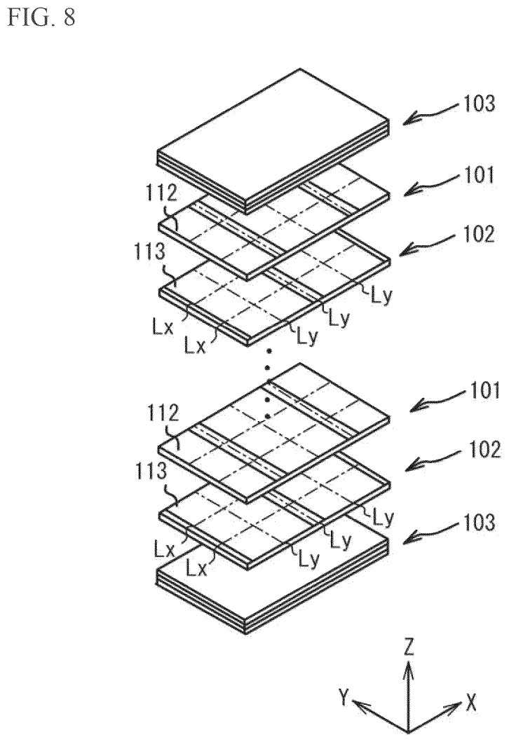

Next, an example of a manufacturing method for the multilayer ceramic capacitor 10 will be described. FIG. 7 is a flowchart illustrating the manufacturing method for the multilayer ceramic capacitor 10. FIG. 8 to FIG. 11 are schematic diagrams illustrating the manufacturing process for multilayer ceramic capacitor 10. Below, the manufacturing method for the multilayer ceramic capacitor 10 will be described in accordance with FIG. 7, with appropriate reference to FIG. 8 to FIG. 11.

### (Step S01: Preparation of Sheet Members)

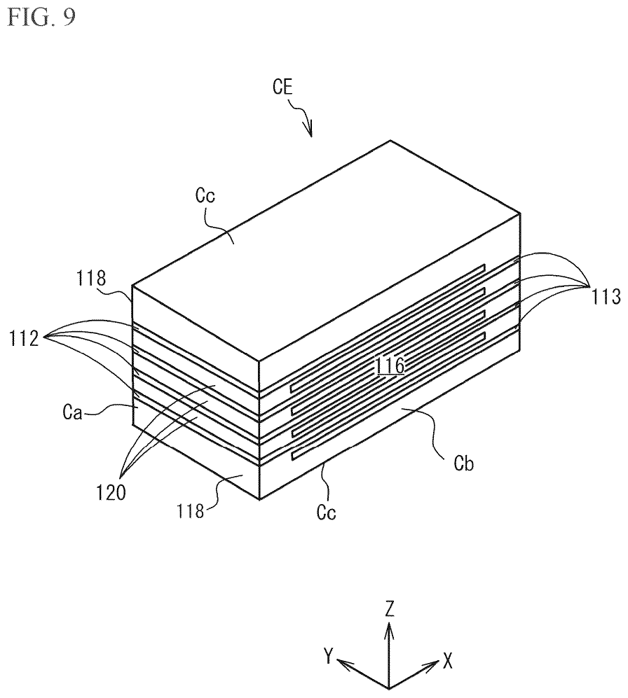

In step S01, ceramic sheets 101, 102, and 103 are fabricated to produce the unfired ceramic multilayer body (multilayer body) C illustrated in FIG. 9. The ceramic sheets 101 and 102 are sheet members for forming the dielectric layers in the capacity section 16. The ceramic sheet 103 is a sheet member for forming the cover.

The ceramic sheets 101, 102, and 103 are all constructed as unfired dielectric green sheets containing a ceramic material primarily composed of dielectric ceramic, an organic binder, and other additives. However, the ceramic sheets 101, 102 and the ceramic sheet 103 differ in the Si source added as a sintering aid. The Si source added to the ceramic sheets 101 and 102 is SiO₂, while the Si source added to ceramic sheet 103 is an organosilicon compound. The organosilicon compound may be at least one of silicon, silicon resin, and silicon oligomer.

The organosilicon compound in the ceramic sheet 103 may be mixed with the ceramic material (ceramic powder) in a range of 3 at % to 9 at %.

To obtain the ceramic sheet 103, a dispersion is prepared by dispersing an organosilicon compound and a binder such as polyvinyl butyral (PVB) resin in an organic solvent such as ethanol or toluene.

Separately from this dispersion, a plasticizer is added to ceramic powder and wet-mixed to obtain a first slurry.

This dispersion liquid is then mixed with the first slurry and emulsified and dispersed to produce a second slurry. This second slurry is then coated onto a substrate film, for example, using a die coater or doctor blade method. The coated slurry is then dried to obtain the ceramic sheet 103. This ceramic sheet 103 has excellent adhesion.

On the other hand, the ceramic sheets 101 and 102 may be produced using conventional methods.

The ceramic sheets 101 and 102 are produced, for example, by the following process.

The ceramic sheets 101 and 102 are obtained by wet-mixing ceramic powder with a binder such as polyvinyl butyral (PVB) resin, an organic solvent such as ethanol or toluene, a plasticizer, and SiO₂ as a sintering aid. Instead of SiO₂, a low-melting-point glass containing B₂O₃ or a mixture thereof may be used as the sintering aid. The low-melting-point glass is such as borosilicate glass or phosphate glass. B₂O₃ powder or P₂O₅ powder may also be used as the sintering aid. This slurry is then applied to a substrate film using, for example, a die coater or doctor blade method, and the coated slurry is dried to obtain the ceramic sheets 101 and 102.

The ceramic powder used as the raw material for the ceramic sheets 101, 102, and 103 is the same, for example, barium titanate powder. Barium titanate powder is synthesized by reacting a titanium source, such as titanium dioxide, with a barium source, such as barium carbonate, using a known method, such as the solid-phase method, the sol-gel method, or the hydrothermal method. The particle size of the ceramic powder used as the starting material is not particularly limited and may be selected appropriately within the conventionally known range.

### (Step S02: Preparation of Ceramic Multilayer Body CE)

In Step S02, the ceramic sheets 101 and 102 for forming the capacity section 16 and the ceramic sheet 103 for forming the cover 18 are stacked and cut to fabricate a ceramic multilayer body (hereinafter simply referred to as “multilayer body”) C.

To fabricate the multilayer body CE, unfired first internal electrode layers 112 corresponding to the first internal electrode layers 12 are first formed on the ceramic sheet 101. Unfired second internal electrode layers 113 corresponding to the second internal electrode layers 13 are also formed on the ceramic sheet 102. No internal electrode layers are formed on the ceramic sheet 103.

Each of the unfired internal electrode layers 112 and 113 has multiple strip-shaped electrode patterns that cross a cutting line Lx parallel to the X direction and extend along a cutting line Ly parallel to the Y direction. These unfired internal electrode layers 112, 113 are formed by applying a conductive paste to the ceramic sheets 101, 102 using a printing method or the like.

As illustrated in FIG. 8, the ceramic sheets 101, 102 are alternately stacked in the Z direction. The multilayer body of the ceramic sheets 101, 102 corresponds to the capacity section 16 and the end margin 20. The ceramic sheet 103 is stacked on the top and bottom surfaces of the multilayer body of the ceramic sheets 101, 102 in the Z direction. The plurality of ceramic sheets 103 are stacked to form the cover 18. The number of the ceramic sheets 101, 102, 103 stacked may be adjusted as needed.

Next, the multilayer body of the ceramic sheets 101, 102, 103 is pressed together in the Z direction and cut along cutting lines Lx and Ly. This produces the multilayer body CE illustrated in FIG. 9. At this time, the ceramic sheet 103 has excellent adhesion, as described above. This improves the adhesion between the ceramic sheet 103 and the ceramic sheets 101 and 102. As a result, in this embodiment, the pressure required during molding may be reduced compared to the conventional method.

The multilayer body CE has an unfired capacity section 116 with the unfired internal electrode layers 112, 113 formed therein, an unfired cover 118, and an unfired end margin 120. The multilayer body CE has a side face Cb, which is a cut surface corresponding to the cutting line Lx, and an end face Ca, which is a cut surface corresponding to the cutting line Ly. The ends of the unfired internal electrode layers 112, 113 are exposed from the side face Cb.

### (Step S03: Formation of Side Margin 119)

In Step S03, a side margin 119 is formed on the side face Cb of the multilayer body CE. An example of the formation method will be described below.

First, a ceramic sheet 104 is prepared as a side margin-forming sheet material for forming the unfired side margin 119. The ceramic sheet 104 has the same composition as the ceramic sheet 103 acting as the cover-forming sheet member. Therefore, the ceramic sheet 104 is prepared in the same manner as the ceramic sheet 103.

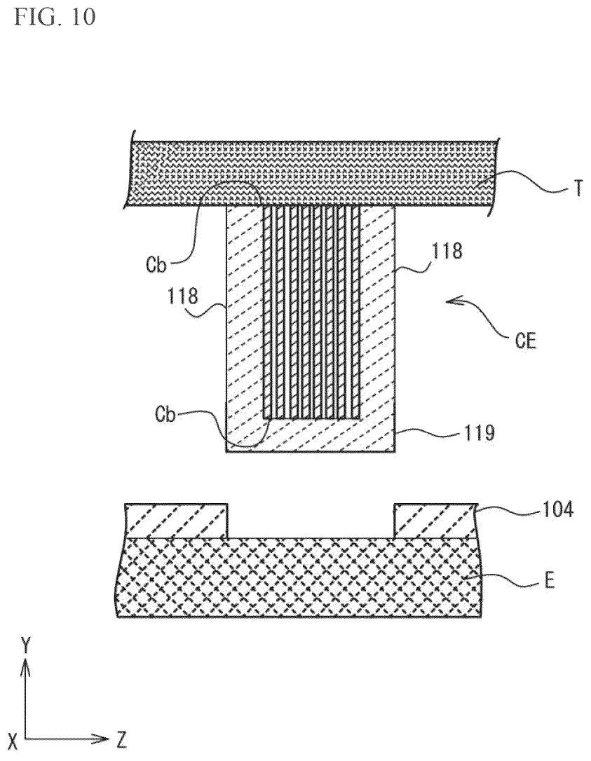

To form the side margin 119 using the ceramic sheet 104, first, as illustrated in FIG. 10, the ceramic sheet 104 is placed on a flat elastic member E. Then, one of the side faces Cb of the multilayer body CE is held in place with a tape T, and the other side face Cb of the multilayer body CE is placed facing the ceramic sheet 104. The elastic member E is made of an elastic material such as rubber.

Then, the ceramic sheet 104 is punched out at the side face Cb of the multilayer body CE, thereby attaching the ceramic sheet 104 to the side face Cb. Specifically, the multilayer body CE is pressed firmly against the ceramic sheet 104 in the Y-axis direction. This causes the multilayer body CE, along with the ceramic sheet 104, to locally sink deeply into the elastic member E. At this time, a shear force acts on the ceramic sheet 104 along the outer edge of the side face Cb, and when this shear force exceeds the shear strength of the ceramic sheet 104, the ceramic sheet 104 is punched out, thereby forming the side margin 119 on the side face Cb.

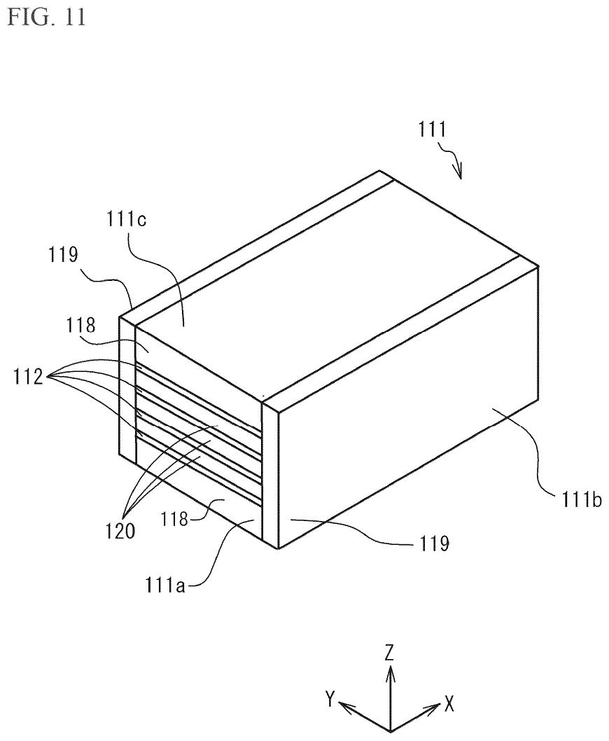

Then, the side margin 119 is similarly formed on the other side face Cb. This results in an unfired ceramic element body 111 illustrated in FIG. 11. By forming the side margin 119 in this manner, the Y-direction end positions of the first internal electrode layer 12 and the second internal electrode layer 13 in the multilayer ceramic capacitor 10 are aligned to within 0.5 μm in the Y-direction on the Y-direction side face of the capacity section 16.

### (Step S04: Firing)

In step S04, the ceramic element body 111 obtained in step S03 is fired to produce the ceramic element body 11 of the multilayer ceramic capacitor 10 illustrated in FIG. 1. The firing temperature in step S04 may be determined based on the sintering temperature of the ceramic element body 111. Furthermore, firing may be performed, for example, in a reducing atmosphere or a low-oxygen partial pressure atmosphere.

The firing temperature may be set in the range of 1150 °C or higher but lower than 1250 °C, more preferably in the range of 1150 °C or higher and 1200 °C or lower.

### (Step S05: Formation of Base Film)

In step S05, the conductive base film 21 is formed on the end faces 11a, the side faces 11b, and the main faces 11c illustrated in FIG. 2 and FIG. 3.

The base film 21 is formed by applying unfired electrode material to the end faces 11a, the side faces 11b, and the main faces 11c. The application method is, for example, a dipping method, but other conventional methods such as printing and sputtering, or a combination of these, may also be used. The unfired electrode material is then baked. Baking may be performed, for example, in a reducing atmosphere or a low-oxygen partial pressure atmosphere.

### (Step S06: Formation of Plating Film)

In step S06, the multilayer ceramic capacitor 10 with the base film 21 formed thereon is immersed in a plating solution that forms the plating film 22, thereby performing electrolytic plating. This forms the plating film 22.

In this manner, the multilayer ceramic capacitor 10 illustrated in FIG. 1 to FIG. 3 is manufactured.

Although the above describes various embodiments of the present invention, the present invention is not limited to the above-described embodiments, and various modifications may be made without departing from the spirit and scope of the present invention.

### EXAMPLES

### [Moisture Resistance Evaluation]

First, the results of the moisture resistance evaluation for Examples will be described along with Comparative Examples. Examples correspond to the multilayer ceramic capacitor 10 of the embodiment. The dielectric ceramic that forms the main component of the dielectric layer 15, the cover 18, and the side margin 19 in Examples is barium titanate (BaTiO₃). For this reason, in the following description, barium titanate will be referred to as BT material, and its particles as BT particles. This also applies to Comparative Examples. The specifications and the results and evaluation of the moisture resistance tests of Examples and Comparative Examples are summarized in Table 1 and Table 2.

First, the conditions for the moisture resistance evaluation test are listed below.

### Test Conditions:

Ambient temperature: 40 °C, ambient humidity: 95%.
Rated voltage:
10 V applied.

### Test Item Dimensions:

0603 (length×width×height=0.6 mm×0.3 mm×0.3 mm)
Note that these values are representative values for the test items and are not limited to these values; other dimensions may also be used.
Number of test items:
100 pieces were used for each of Examples and each of Comparative Examples.

The test results are evaluated to determine whether any changes in appearance or reductions in capacity occurred when the test was conducted under the above conditions. Test results are indicated by “∘”, “Δ” and “×”. A defect rate of 0-3% is indicated as “∘”, a defect rate of 3-5% is indicated as “Δ”, and a defect rate of 5% or more is indicated as “×”. Only test results with “∘” result were evaluated as “∘” (pass); all other results, i.e., test results with “Δ” or “×”, were evaluated as “×” (fail).

Here, the items included in the specifications for Examples and Comparative Examples will be described.

The firing temperature refers to the firing temperature in step S04 of the flowchart illustrated in FIG. 7.

The average particle size of the margin BT material [nm] refers to the particle size of the BT material used as the starting material for the margin, that is, the average starting particle size. Here, the margin includes both the cover 18 and the side margin 19.

The type of Si source added as the sintering aid is shown for the cover 18, the side margin 19, and the dielectric layer 15 that forms the capacity section 16. Silicon oligomer was used as the organosilicon compound.

The average particle size of the margin BT material is the starting particle size of the BT material. Meanwhile, the average grain size indicates the average grain size [μm] of BT grains in the cover 18, the side margin 19, and the dielectric layer 15 forming the capacity section 16. The average grain size was evaluated using cross-sectional images taken with an SEM after sample multilayer ceramic capacitors for Examples and Comparative Examples were polished to the center in the X direction, with the X direction perpendicular to the polished surface. Specifically, the longest dimension of each BT grain was measured in the cross-sectional image, and the average value was used as the average grain size. In other words, the average grain size is the average grain size of the BT grains after firing. The number of samples was n=100 for each of Examples and each of Comparative Examples.

The number of BT grains C surrounding a glass grain G (number) indicates the number of BT grains C in contact with one glass grain G for each of the cover 18, the side margin 19, and the dielectric layer 15 that forms the capacity section 16. The number of BT grains was obtained by counting the glass grains G (n=50) present in each section using the cross-sectional images taken with the SEM described above, and rounding off the average.

The standard deviation [μm] of grain size in the region between the boundaries indicates the standard deviation of the grain size of BT grains in the first region Ar1 and the second region Ar2 illustrated in FIG. 4. Specifically, using the cross-sectional images taken with the SEM described above, the longest dimension of n=200 BT grains was measured in each of the first region Ar1 and the second region Ar2, and the standard deviation was calculated.

TABLE 1

| | FIRING | AVERAGE | Si SOURCE | | |
|---|---|---|---|---|---|
| | TEMPERATURE | PARTICLE | | SIDE | CAPACITY |
| | [°C] | SIZE OF | COVER | MARGIN | SECTION |
| EXAMPLE 1 | 1200 | 102 | ORGANO- | ORGANO- | SiO₂ |
| | | | SILICON | SILICON | |
| | | | COMPOUND | COMPOUND | |
| EXAMPLE 2 | 1200 | 149 | ORGANO- | ORGANO- | SiO₂ |
| | | | SILICON | SILICON | |
| | | | COMPOUND | COMPOUND | |
| EXAMPLE 3 | 1200 | 198 | ORGANO- | ORGANO- | SiO₂ |
| | | | SILICON | SILICON | |
| | | | COMPOUND | COMPOUND | |
| EXAMPLE 4 | 1200 | 498 | ORGANO- | ORGANO- | SiO₂ |
| | | | SILICON | SILICON | |
| | | | COMPOUND | COMPOUND | |
| EXAMPLE 5 | 1200 | 51 | ORGANO- | ORGANO- | SiO₂ |
| | | | SILICON | SILICON | |
| | | | COMPOUND | COMPOUND | |
| EXAMPLE 6 | 1170 | 102 | ORGANO- | ORGANO- | SiO₂ |
| | | | SILICON | SILICON | |
| | | | COMPOUND | COMPOUND | |
| EXAMPLE 7 | 1150 | 102 | ORGANO- | ORGANO- | SiO₂ |
| | | | SILICON | SILICON | |
| | | | COMPOUND | COMPOUND | |
| COMPARATIVE | 1200 | 102 | SiO₂ | SiO₂ | SiO₂ |
| EXAMPLE 1 | | | | | |
| COMPARATIVE | 1200 | 102 | SiO₂ | ORGANO- | SiO₂ |
| EXAMPLE 2 | | | | SILICON | |
| | | | | COMPOUND | |
| COMPARATIVE | 1250 | 102 | ORGANO- | ORGANO- | SiO₂ |
| EXAMPLE 3 | | | SILICON | SILICON | |
| | | | COMPOUND | COMPOUND | |
| COMPARATIVE | 1300 | 102 | ORGANO- | ORGANO- | SiO₂ |
| EXAMPLE 4 | | | SILICON | SILICON | |
| | | | COMPOUND | COMPOUND | |
| COMPARATIVE | 1100 | 102 | ORGANO- | ORGANO- | SiO₂ |
| EXAMPLE 5 | | | SILICON | SILICON | |
| | | | COMPOUND | COMPOUND | |

| | AVERAGE GRAIN SIZE | | | NUMBER OF BT GRAINS | | |
|---|---|---|---|---|---|---|
| | | SIDE | CAPACITY | | SIDE | CAPACITY |
| | COVER | MARGIN | SECTION | COVER | MARGIN | SECTION |
| EXAMPLE 1 | 0.19 | 0.18 | 0.43 | 5 | 5 | 3 |
| EXAMPLE 2 | 0.24 | 0.25 | 0.43 | 5 | 5 | 3 |
| EXAMPLE 3 | 0.32 | 0.33 | 0.43 | 5 | 5 | 3 |
| EXAMPLE 4 | 0.62 | 0.61 | 0.43 | 5 | 5 | 3 |
| EXAMPLE 5 | 0.08 | 0.09 | 0.43 | 5 | 5 | 3 |
| EXAMPLE 6 | 0.18 | 0.17 | 0.43 | 6 | 6 | 3 |
| EXAMPLE 7 | 0.13 | 0.14 | 0.43 | 8 | 8 | 3 |
| COMPARATIVE | 0.23 | 0.24 | 0.43 | 3 | 3 | 3 |
| EXAMPLE 1 | | | | | | |
| COMPARATIVE | 0.22 | 0.18 | 0.43 | 3 | 5 | 3 |
| EXAMPLE 2 | | | | | | |
| COMPARATIVE | 0.25 | 0.26 | 0.43 | 4 | 4 | 3 |
| EXAMPLE 3 | | | | | | |
| COMPARATIVE | 0.31 | 0.32 | 0.43 | 3 | 3 | 3 |
| EXAMPLE 4 | | | | | | |
| COMPARATIVE | 0.1 | 0.1 | 0.2 | 12 | 12 | 5 |
| EXAMPLE 5 | | | | | | |

TABLE 2

| | STANDARD | MOISTURE | |
|---|---|---|---|
| | DEVIATION | RESISTANCE | JUDGE |
| EXAMPLE 1 | 0.05 | ◯ | ◯ |
| EXAMPLE 2 | 0.05 | ◯ | ◯ |
| EXAMPLE 3 | 0.05 | ◯ | ◯ |
| EXAMPLE 4 | 0.05 | ◯ | ◯ |
| EXAMPLE 5 | 0.05 | ◯ | ◯ |
| EXAMPLE 6 | 0.05 | ◯ | ◯ |
| EXAMPLE 7 | 0.05 | ◯ | ◯ |
| COMPARATIVE | 0.05 | X | X |
| EXAMPLE 1 | | | |
| COMPARATIVE | 0.06 | X | X |
| EXAMPLE 2 | | | |
| COMPARATIVE | 0.05 | Δ | X |
| EXAMPLE 3 | | | |
| COMPARATIVE | 0.05 | X | X |
| EXAMPLE 4 | | | |
| COMPARATIVE | 0.05 | X | * |
| EXAMPLE 5 | | | |

### Example 1

Firing temperature: 1200 °C
Average particle size of BT material in margin: 102 nm
Si source:
   Cover: Organosilicon compound
   Side margin: Organosilicon compound
   Capacity section: SiO₂
Average grain size:
   Cover: 0.19 μm
   Side margin: 0.18 μm
   Capacity section: 0.43 μm
Number of BT grains surrounding a glass grain:
   Cover: 5 grains
   Side margin: 5 grains
   Capacity section: 3 grains
Standard deviation of grain size: 0.05
Moisture resistance test: “∘”
Judge: “∘”

### Example 2

Firing temperature: 1200 °C
Average particle size of BT material in margin: 149 nm
Si source:
   Cover: Organosilicon compound
   Side margin: Organosilicon compound
   Capacity section: SiO₂
Average grain size:
   Cover: 0.24 μm
   Side margin: 0.25 μm
   Capacity section: 0.43 μm
Number of BT grains surrounding a glass grain:
   Cover: 5 grains
   Side margin: 5 grains
   Capacity section: 3 grains
Standard deviation of grain size: 0.05
Moisture resistance test: “∘”
Judge: “∘”

### Example 3

Firing temperature: 1200 °C
Average particle size of BT material in margin: 198 nm
Si source:
   Cover: Organosilicon compound
   Side margin: Organosilicon compound
   Capacity section: SiO₂
Average grain size:
   Cover: 0.32 μm
   Side margin: 0.33 μm
   Capacity section: 0.43 μm
Number of BT grains surrounding a glass grain:
   Cover: 5 grains
   Side margin: 5 grains
   Capacity section: 3 grains
Standard deviation of grain size: 0.05
Moisture resistance test: “∘”
Judge: “∘”

### Example 4

Firing temperature: 1200 °C.
Average particle size of BT material in margin: 498 nm
Si source:
   Cover: Organosilicon compound
   Side margin: Organosilicon compound
   Capacity section: SiO₂
Average grain size:
   Cover: 0.62 μm
   Side margin: 0.61 μm
   Capacity section: 0.43 μm
Number of BT grains surrounding a glass grain:
   Cover: 5 grains
   Side margin: 5 grains
   Capacity section: 3 grains
Standard deviation of grain size: 0.05
Moisture resistance test: “∘”
Judge: “∘”

### Example 5

Firing temperature: 1200 °C
Average particle size of BT material in margin: 51 nm
Si source:
   Cover: Organosilicon compound
   Side margin: Organosilicon compound
   Capacity section: SiO₂
Average grain size:
   Cover: 0.08 μm
   Side margin: 0.09 μm
   Capacity section: 0.43 μm
Number of BT grains surrounding a glass grain:
   Cover: 5 grains
   Side margin: 5 grains
   Capacity section: 3 grains
Standard deviation of grain size: 0.05
Moisture resistance test: “∘”
Judge: “∘”

### Example 6

Firing temperature: 1170 °C.
Average particle size of BT material in margin: 102 nm
Si source:
   Cover: Organosilicon compound
   Side margin: Organosilicon compound
   Capacity section: SiO₂
Average grain size:
   Cover: 0.18 μm
   Side margin: 0.17 μm
   Capacity section: 0.43 μm
Number of BT grains surrounding a glass grain:
   Cover: 6 grains
   Side margin: 6 grains
   Capacity section: 3 grains
Standard deviation of grain size: 0.05
Moisture resistance test: “∘”
Judge: “∘”

### Example 7

Firing temperature: 1150 °C.
Average particle size of BT material in margin: 102 nm
Si source:
   Cover: Organosilicon compound
   Side margin: Organosilicon compound
   Capacity section: SiO₂
Average grain size:
   Cover: 0.13 μm
   Side margin: 0.14 μm
   Capacity section: 0.43 μm
Number of BT grains surrounding a glass grain:
   Cover: 8 grains
   Side margin: 8 grains
   Capacity section: 3 grains
Standard deviation of grain size: 0.05
Moisture resistance test: “∘”
Judge: “∘”

### Comparative Example 1

Firing temperature: 1200 °C
Average particle size of BT material in margin: 102 nm
Si source:
   Cover: SiO₂
   Side margin: SiO₂
   Capacity section: SiO₂
Average grain size:
   Cover: 0.23 μm
   Side margin: 0.24 μm
   Capacity section: 0.43 μm
Number of BT grains surrounding a glass grain:
   Cover: 3 grains
   Side margin: 3 grains
   Capacity section: 3 grains
Standard deviation of grain size: 0.05
Moisture resistance test: “×”
Judge: “×”

### Comparative Example 2

Firing temperature: 1200 °C
Average particle size of BT material in margin: 102 nm
Si source:
   Cover: SiO₂
   Side margin: Organosilicon compound
   Capacity section: SiO₂
Average grain size:
   Cover: 0.22 μm
   Side margin: 0.18 μm
   Capacity section: 0.43 μm
Number of BT grains surrounding a glass grain:
   Cover: 3 grains
   Side margin: 5 grains
   Capacity section: 3 grains
Standard deviation of grain size: 0.06
Moisture resistance test: “×”
Judge: “×”

### Comparative Example 3

Firing temperature: 1250 °C.
Average particle size of BT material in margin: 102 nm
Si source:
   Cover: Organosilicon compound
   Side margin: Organosilicon compound
   Capacity section: SiO₂
Average grain size:
   Cover: 0.25 μm
   Side margin: 0.26 μm
   Capacity section: 0.43 μm
Number of BT grains surrounding a glass grain:
   Cover: 4 grains
   Side margin: 4 grains
   Capacity section: 3 grains
Standard deviation of grain size: 0.05
Moisture resistance test: “Δ”
Judge: “×”

### Comparative Example 4

Firing temperature: 1300 °C.
Average particle size of BT material in margin: 102 nm
Si source:
   Cover: Organosilicon compound
   Side margin: Organosilicon compound
   Capacity section: SiO₂
Average grain size:
   Cover: 0.31 μm
   Side margin: 0.32 μm
   Capacity section: 0.43 μm
Number of BT grains surrounding a glass grain:
   Cover: 3 grains
   Side margin: 3 grains
   Capacity section: 3 grains
Standard deviation of grain size: 0.05
Moisture resistance test: “×”
Judge: “×”

### Comparative Example 5

Firing temperature: 1100 °C.
Average particle size of BT material in margin: 102 nm
Si source:
   Cover: Organosilicon compound
   Side margin: Organosilicon compound
   Capacity section: SiO₂
Average grain size:
   Cover: 0.1 μm
   Side margin: 0.1 μm
   Capacity section: 0.2 μm
Number of BT grains surrounding a glass grain:
   Cover: 12 grains
   Side margin: 12 grains
   Capacity section: 5 grains
Standard deviation of grain size: 0.05
Moisture resistance test: “×”
Judge: *
*In Comparative Example 5, the particle size of the starting material was approximately the same as the grain size of the grains in the cover 18 and the side margin 19 after firing, indicating that little grain growth occurred during firing. As a result, the grain bonds were weak and the mechanical strength was low, making it difficult to use in a moisture resistance test.

### [Effect of the Number of BT Grains Surrounding Glass Grain]

All of Examples 1 through 7 were judged as “∘” (acceptable). In contrast, all of Comparative Examples 1 through 4 were judged as “×” (unacceptable). In Examples 1 through 7, the number of BT grains surrounding the glass grain in the cover 18 and the side margin 19 was five or more. In contrast, Comparative Examples 1 through 4 included locations in either the cover or the side margin where the number of BT grains C surrounding the glass grain G was four or less. For example, in Comparative Example 2, the number of BT grains C surrounding the glass grain G in the side margin was five. However, the number of BT grains C surrounding the glass grain G in the cover was three. This result suggest that moisture resistance can be improved by satisfying the condition that the number of BT grains C surrounding each glass grain G in both the cover and the side margin is five or more.

### [Effect of Si Source]

In Examples 1 to 7, the Si source for the cover 18 and the side margin 19, where the number of BT grains surrounding each glass grain is five, is an organosilicon compound. On the other hand, the Si source for the capacity section 16, where the number of BT grains C surrounding each glass grain B is three, is SiO₂. Based on this relationship, it is believed that using an organosilicon compound as the Si source is necessary to ensure that the number of BT grains C surrounding each glass grain G is five or more. This is also evident from a comparison between Example 1 and Comparative Example 1. The difference between Example 1 and Comparative Example 1 is the Si source for the cover and the side margin. In Comparative Example 1, the Si source for the cover and the side margin is SiO₂. As a result, in Comparative Example 1, the number of BT grains C surrounding each glass grain G is three. Furthermore, based on the configuration of Comparative Example 2, it is believed necessary to use an organosilicon compound as the Si source to ensure that the number of BT grains surrounding each glass grain is five or more. Specifically, in the side margin of Comparative Example 2, the number of BT grains C surrounding each glass grain is five. This is thought to be due to the use of an organosilicon compound as the Si source for the side margin in Comparative Example 2.

Note that Examples 1 to 5 have the same firing temperature but different average particle sizes of the margin BT material. Furthermore, when focusing on the average grain sizes of the cover 18 and the side margin 19 in Examples 1 to 5, the average grain sizes of the cover 18 and the side margin 19 follow the order of the average particle sizes of the marginal BT material. However, in Examples 1 to 5, the number of BT grains C surrounding each glass grain G in the cover 18 and the side margin 19 was five. This result suggests that, in order to achieve the number of BT grains C surrounding each glass grain G of five or more, an organosilicon compound may be used as the Si source, regardless of the average particle size of the margin BT material. Specifically, for example, while Examples 3 and 4 have the same standard deviation of grain size, the starting materials differ by approximately 2.5 times. Generally, using larger particles as starting materials increases the standard deviation of grain size after firing. However, in these Examples, the use of glass particles ensures that the standard deviation is kept to 0.05 μm, even when the particle size of the starting materials is large.

### [Effect of Sintering Temperature]

Next, the effect of sintering temperature will be described. The firing temperature in Example 1 was 1200 °C, and the number of BT grains C surrounding the glass grain G in the cover 18 and the side margin 19 was five. The firing temperature in Example 6 was 1170 °C, and the number of BT grains C surrounding the glass grain G in the cover 18 and the side margin 19 was 6. The firing temperature in Example 7 was 1150 °C, and the number of BT grains C surrounding the glass grain G in the cover 18 and the side margin 19 was 8. From these results, it is thought that when the firing temperature is 1170 °C or lower, the growth of the BT grains C is suppressed and the number of BT grains C surrounding the glass grain G increases.

On the other hand, the firing temperature in Comparative Example 3 was 1250 °C, and the number of BT grains C surrounding the glass grain G in the cover 18 and side margin 19 was four. Furthermore, the firing temperature in Comparative Example 4 was 1300 °C, and the number of BT grains C surrounding glass grain G in the cover and the side margin was four. It is believed that the firing temperature of 1250 °C or more causes significant growth of BT grains C, leading to a decrease in the number of BT grains C surrounding the glass grain G.

In Comparative Example 5, the firing temperature was 1100 °C, and the number of BT grains C surrounding glass grain G in the cover 18 and the side margin 19 was 12. However, the particle size of the starting material was approximately the same as the grain size of the grains in the cover 18 and side margin 19 after firing, indicating that grain growth during firing barely progressed. As a result, the bonds between the BT grains C were weakened, and the mechanical strength of the cover 18 and the side margin 19 was too weak to be used in a moisture resistance test. In other words, Comparative Example 5 lacked sufficient mechanical strength to be considered a complete multilayer ceramic electronic component.

According to Comparative Examples 3 to 5, when the firing temperature is 1250 °C or higher, the BT grains C grow significantly, leading to a decrease in the number of BT grains C surrounding the glass grain G. When the firing temperature is lower than 1150 °C, the BT grains C hardly grow, and even if the number of BT grains C surrounding the glass grain G increases, the voids between the BT grains C do not disappear, and the mechanical strength tends to decrease.

For these reasons, it is desirable that the firing temperature in the process of firing the unfired body be 1150 °C or higher and lower than 1250 °C. Furthermore, it is desirable that the firing temperature be 1150 °C or higher and 1200 °C or less.

### [Pressure Required During Molding]

Next, the pressure required during molding will be described based on Table 3. Table 3 shows the pressure required during molding for Example 1, Comparative Example 1, and Comparative Example 3. If the pressure required for Comparative Example 1 is 100%, the pressure required for Example 1 is 85%, a 15% reduction. This is thought to be due to the high adhesion of the ceramic sheet 103 forming the cover 18. Reducing the required pressure is expected to suppress delamination of the internal electrodes. This suppression of delamination is expected to reduce the short-circuit rate and improve yield. In Comparative Example 3, due to the high firing temperature, the number of BT grains C surrounding the glass grain G in the cover and the side margin was four. However, the same ceramic sheet was used for both the cover 18 and the side margin 19. As a result, adhesion was improved and the required pressure itself was reduced.

Based on this, it is believed that using the same ceramic sheet for the cover 18 and the side margin 19 is effective in reducing the required pressure.

### [Delamination Rate]

Next, the relationship between the silicon source and the delamination rate will be described based on Table 3. Table 3 shows that, compared to Example 1, the delamination occurrence rate was higher in Comparative Example 3, in which the silicon source for the cover 18 and the side margin 19 was changed from SiO₂ to an organosilicon compound at the same pressure. However, delamination did not occur in Example 1, in which the pressure was lowered from Comparative Example 3 without changing the silicon source. In other words, it can be considered that delamination occurred in Comparative Example 3 because a pressure excessively higher than the required pressure was applied.

TABLE 3

| | AVERAGE | | | | | |
|---|---|---|---|---|---|---|
| | PARTICLE | | | | | |
| | SIZE OF | | | | | DELAMINATION |
| | MARGIN BT | Si SOURCE | | | PRESSURE | OCCURRENCE |
| | MATERIAL | | SIDE | CAPACITY | FOR MOLDING | RATE |
| | [nm] | COVER | MARGIN | SECTION | [%] | [%] |
| COMPARATIVE | 100 | SiO₂ | SiO₂ | SiO₂ | 100 | 0 |
| EXAMPLE 1 | | | | | | |
| COMPARATIVE | 100 | ORGANO- | ORGANO- | SiO₂ | 100 | 5 |
| EXAMPLE 3 | | SILICON | SILICON | | | |
| | | COMPOUND | COMPOUND | | | |
| EXAMPLE 1 | 198 | ORGANO- | ORGANO- | SiO₂ | 85 | 0 |
| | | SILICON | SILICON | | | |
| | | COMPOUND | COMPOUND | | | |

In the above embodiment, the multilayer ceramic capacitor 10 is described as an example of a multilayer ceramic electronic component. However, the present invention is applicable to all multilayer ceramic electronic components in which dielectric layers and internal electrodes are stacked. Examples of such multilayer ceramic electronic components include chip varistors, chip thermistors, and multilayer inductors.

What is claimed is:

1. A multilayer ceramic electronic component comprising:
an element body having a multilayer body including a pair of covers that cover a capacity section formed by alternately stacking first internal electrode layers and second internal electrode layers along a first direction with a dielectric layer sandwiched therebetween, the dielectric layer being mainly composed of ceramic crystal grains, from both sides in the first direction, and a side margin that covers the multilayer body from a second direction orthogonal to the first direction; and
a first external electrode formed on a surface of the element body and having the first internal electrode layer drawn out; and a second external electrode formed on the surface of the element body so as to be spaced apart from the first external electrode and having the second internal electrode layer drawn out,
wherein as viewed in a cross section of the element body including the first direction and the second direction, the cover and the side margin each include glass grains and crystal grains of a same composition surrounding individual glass grains, a number of the crystal grains of the same composition surrounding a glass grain being five or more on average, and an average number of the crystal grains of the same composition surrounding a glass grain in the cover is equal to or within ±20% of the average number of the crystal grains of the same composition surrounding a glass grain in the side margin.

2. The multilayer ceramic electronic component as claimed in claim 1,
wherein positions of ends of the first internal electrode layers and the second internal electrode layers in the second direction are aligned with each other within a range of 0.5 μm in the second direction.

3. The multilayer ceramic electronic component as claimed in claim 1,
wherein the crystal grains have a perovskite structure containing barium and titanium.

4. The multilayer ceramic electronic component as claimed in claim 1,
wherein as viewed in the cross section of the element body including the first direction and the second direction, when an imaginary boundary line between the cover and the side margin, and a first region on a cover side and a second region on a side margin side adjacent to each other across the imaginary boundary line are set, a standard deviation of grain size of the crystal grains measured in the first region and a standard deviation of the grain size of the crystal grains measured in the second region are 0.05 μm or less.

5. The multilayer ceramic electronic component as claimed in claim 1,
wherein an amount of Si element in the cover and the side margin is 3 at % or more with respect to an entire material forming the cover and the side margin.

6. The multilayer ceramic electronic component as claimed in claim 1,
wherein a volume ratio of glass to a main component ceramic in the cover and the side margin is 1% or more and 20% or less.

7. The multilayer ceramic electronic component as claimed in claim 1,
wherein a median diameter of the glass grain in the cover and the side margin is 0.20 μm or more and 0.80 μm or less.

8. The multilayer ceramic electronic component as claimed in claim 1,
wherein a Si element concentration in the cover and the side margin is discontinuous with a Si element concentration in the capacity section.

9. The multilayer ceramic electronic component as claimed in claim 1,
wherein a Si element concentration in the cover and the side margin is discontinuous with a Si element concentration in an end margin.

10. A manufacturing method of a multilayer ceramic electronic component comprising:
preparing an unfired multilayer body, which includes a capacity section in which dielectric layers and internal electrode layers are alternately stacked along a first direction, the internal electrode layers being exposed from side faces facing a second direction orthogonal to the first direction, and a pair of covers formed by cover-forming sheet members that cover the capacity section from both sides in the first direction;
forming an unfired element body by pressing the side faces of the unfired multilayer body against a side margin-forming sheet member, which is disposed on an elastic member, to punch out the side margin-forming sheet member, thereby forming a side margin on the side faces;
firing the unfired element body; and
forming an external electrode,
wherein
a main component of the cover-forming sheet member and the side margin-forming sheet member is ceramics, and the cover-forming sheet member and the side margin-forming sheet member contain an organic silicon compound and have a composition different from that of a dielectric layer-forming sheet member that forms the dielectric layer in the capacity section.

11. The method as claimed in claim 10,
wherein the organosilicon compound includes at least one of silicon, silicon resin, or silicon oligomer.

12. The method as claimed in claim 10,
wherein a content of the organosilicon compound is 3 at % or more and 9 at % or less with respect to the main component.

13. The method as claimed in claim 10,
wherein the cover-forming sheet member and the side margin-forming sheet member are prepared by preparing a dispersion liquid in which an organosilicon compound and a binder are dispersed in a solvent, and then emulsifying and dispersing the dispersion liquid and a first slurry containing ceramics to prepare a second slurry, and using the second slurry.

14. The method as claimed in claim 10,
wherein a firing temperature in the firing of the unfired element body is 1150 °C or higher and lower than 1250 °C.

15. The method as claimed in claim 10,
wherein a firing temperature in the firing of the unfired element body is 1150 °C or higher and 1200 °C or lower.
